(19) United States
(12) Patent Application Publication
(10) Pub. No.: US 2014/0258004 A1
(43) Pub. Date: Sep. 11, 2014

(54) Method for Improving Internet Text Advertisement Visibility

(71) Applicant: Michael ALVES, Canandaigua, NY (US)

(72) Inventor: Michael ALVES, Canandaigua, NY (US)

(21) Appl. No.: 13/789,317

(22) Filed: Mar. 7, 2013

(51) Int. Cl. G06Q 30/02

(52) U.S. Cl. CPC G06Q 30/0277
USPC 705/14.73

(57) ABSTRACT

A method for improving internet text advertisement visibility highlights text advertisements on a web page in order to attract a viewer's attention to the advertisement. At least one text element is selected from at least one of a plurality of text advertisements on a web page. A specific element is designated to be highlighted from the at least one text element. A highlight color is designated for the specific element. The specific element of the at least one specific advertisement is displayed in the highlight color on the web page, while the other advertisements are displayed in a standard color. The specific element is dynamically changed from the standard color to the highlight color, or the specific element is statically displayed in the highlight color. Multiple advertisements may be highlighted one after the other.

### FIELD of THE INVENTION

The present invention relates generally to advertising. More particularly, the present invention relates to a method for improving visibility of text advertisements on internet web pages.

### BACKGROUND OF THE INVENTION

Advertising is a form of communication for marketing, which is the process of communicating the value of a product or service to customers. Advertising is used to encourage or persuade an audience to continue an action or to take some new action. Most commonly, the desired result is to drive consumer behavior with respect to a commercial offering, although political and ideological advertising is also common. Advertising messages are usually paid for by sponsors and viewed via various media, including mass media such as newspaper, magazines, television, radio, outdoor advertising or direct mail, or new media such as blogs, websites or text messages.

The internet has become an ongoing, emerging source that tends to expand more and more over time. The growth of this particular medium has attracted the attention of advertisers as a prolific source to bring in consumers. Online advertising is a form of promotion that uses the internet for the express purpose of delivering marketing messages to attract customers. Online advertisements are generally delivered by an ad server and may take a variety of different forms, such as contextual ads that appear on search engine results pages, banner ads, in-text ads, social network advertising, online classified advertising, and e-mail marketing. The three most common ways in which online advertising is purchased are cost per mile, or per thousand loads of an advertisement, cost per click, which is when advertisers pay each time a user clicks on an advertisement, or cost per action, which pays for number of actions such as a purchase or sign-up. One major benefit of online advertising is the immediate publishing of information and content that is not limited by geography or time. Another benefit is the efficiency of the advertiser's investment-online advertising allows for the customization of advertisements, including content and posted web sites. A website can gather data about a user, and use that data to tailor advertisements toward the user. For example, if a user performs a search for a computer, a website may then use that information to present the user with advertisements for computers or computer accessories.

One clear advantage consumers have with online advertising is the control they have in choosing whether to heed advertisements or not. Advertising on the internet is extremely prevalent, with advertisements being displayed on a very large number of websites. A typical internet user is constantly bombarded with advertising and realistically cannot afford the time or energy to evaluate every advertisement they are presented with. This leads to a phenomenon known as banner blindness, or ad blindness, which is where visitors to a website consciously or subconsciously ignore banner-like information or other advertisements. Most users wish to browse the internet uninterrupted, so advertisers must invent strategies to make online advertising more effective.

It is therefore an object of the present invention to provide a method for improving internet text advertisement visibility by dynamically changing the color of text advertisements on a web page. The present invention may be referred to as “Chameleon Mode” due to the similar characteristic of dynamically changing color.

### BRIEF DESCRIPTION OF THE DRAWINGS

FIG. 1 is a stepwise flow diagram describing the overall process of the present invention.

FIG. 2 is a stepwise flow diagram describing the process for selecting the at least one specific advertisement from the plurality of text advertisements using a highlighting order list.

FIG. 3 is a stepwise flow diagram describing the process for selecting the at least one specific advertisement from the plurality of text advertisements using a pseudorandomly generated number.

FIG. 4 is a stepwise flow diagram describing the process for selecting the specific element from the at least one text element using a highlighting order list.

FIG. 5 is a stepwise flow diagram describing the process for selecting the specific element from the at least one text element using a pseudorandomly generated number.

FIG. 6 is a stepwise flow diagram specifying the process for choosing the highlight color in one embodiment of the present invention.

FIG. 7 is a stepwise flow diagram specifying the process for choosing the highlight color in another embodiment of the present invention.

FIG. 8 is a stepwise flow diagram describing the process of dynamically highlighting the specific element.

FIG. 9 is a stepwise flow diagram describing the process of statically highlighting the specific element.

### DETAIL DESCRIPTIONS OF THE INVENTION

All illustrations of the drawings are for the purpose of describing selected versions of the present invention and are not intended to limit the scope of the present invention.

The present invention is a method of improving internet text advertisement visibility on internet web pages. The present invention is implemented in the source code or other control aspects of internet web pages using one or more appropriate programming languages or other internet web page resources. The present invention provides a method for advertisers to fight “ad blindness” by dynamically or statically changing the color of one or more text elements from one or more text advertisements, or ads, on a web page in an attempt to draw the user's attention to the one or more text advertisements. The effect of the present invention in dynamically changing colors is somewhat similar to how a chameleon changes the color of its skin, so the present invention may be referred to as “Chameleon Mode.”

The present invention is a portion of programming code in any appropriate programming language or other web page feature or tool that may be utilized to accomplish the purpose of the present invention, such as, but not limited to, hypertext markup language (HTML), cascading style sheet (CSS) manipulation, JavaScript, PHP, Perl, Ruby, Python, Java, MySQL, or .NET framework. The programming code of the present invention is embedded on either the computer or computers running a web server, the software on said computer or computers that helps to deliver web content, or both, as an application server, a virtual server, or any other software, application or equipment that may be used to facilitate the purpose of the present invention.

The present invention relates only to text ads, and not other ads, such as images, videos, sound files, banner ads, or embedded flash documents. Examples of ads utilized in the preferred embodiment of the present invention include, but are not limited to, pay per click text ads, in-text ads, and unit text ads in a designated web page section. Any ad utilized with the present invention comprises one or more text elements, such as, but not limited to, body text, title text, or a web hyperlink. Some ads utilized with the present invention may comprise only one text element, such as an in-text ad. Any web page that utilizes the present invention may have any number of text ads, each with any number of text elements. For example, a web page may only have one ad with one text element, or a web page may have several ads of different types, with each of the several ads having the same or different numbers of text elements.

Pay per click text ads refer to ads that typically appear on a web page alongside search engine results. The pay per click text ads may appear in the list of search engine results with the same or similar format as the search engine results, or the pay per click text ads may appear in a section of the web page separate from the search results such as a sidebar, or the pay per click ads may appear in a different location on the search results web page.

In-text advertising is a form of contextual advertising where specific keywords within the text of a web page are matched with advertising and/or related information units gathered about a user, such as searches performed or product pages viewed, in order to target an ad toward the user's preferences. An in-text ad is a word or a group of words displayed on a web page chosen by the web page to be highlighted in some fashion depending on information gathered about the user. The in-text ad may behave differently depending on how the web site owner decides to use the in-text ad. The in-text ad may display information when the user covers the in-text ad with a cursor, or an in-text ad may be a link that takes the user to a different web page, or the in-text ad may perform another function.

Unit text ads in a designated web page section refer to text ads that appear on web pages that are not search results pages. Unit text ads are typically portions of code provided by an advertiser or advertising service to a web site owner, who then embeds the code on their web site in any manner they choose or as dictated by the advertising provider. The portion of code provided by the advertising service retrieves an ad from the advertising service's servers and displays the ad in the designated web page section. The location of the designated web page section on the web page is typically determined by the web site owner, but is often featured in a prominent location to encourage users to look at, click on or otherwise interact with the ad.

The present invention is a method that, when implemented on a web page, changes the color of one portion of a text ad, an entire text ad, or multiple portions of multiple text ads to a highlight color to try to attract a viewer's attention. In the preferred embodiment of the present invention, text ads are highlighted dynamically; this means that when the web page loads, all of the text ads are displayed in an initial color, and then the font color of one or more text ads or portions of text ads are gradually changed to a highlight color. In the preferred embodiment of the present invention, the text ads are highlighted one at a time in a cyclical or otherwise dynamically patterned manner for as long as the a user views the web page. In alternate embodiments of the present invention, multiple text ads are simultaneously highlighted in a cyclical manner, or only one text ad is statically highlighted, or multiple text ads are statically highlighted at the same time. In embodiments where one or more text advertisements is statically highlighted, the highlighted text advertisements are unchangingly displayed in the highlight color for the entire time the user views the web page. In another embodiment of the present invention, some text advertisements on the web page may be dynamically highlighted, while other text advertisements are statically highlighted at the same time. In the preferred embodiment of the present invention, the highlighting effect appears random to a user so that one ad is not given an advantage over another ad, but the web page owner may choose to specify a certain order for highlighting ads.

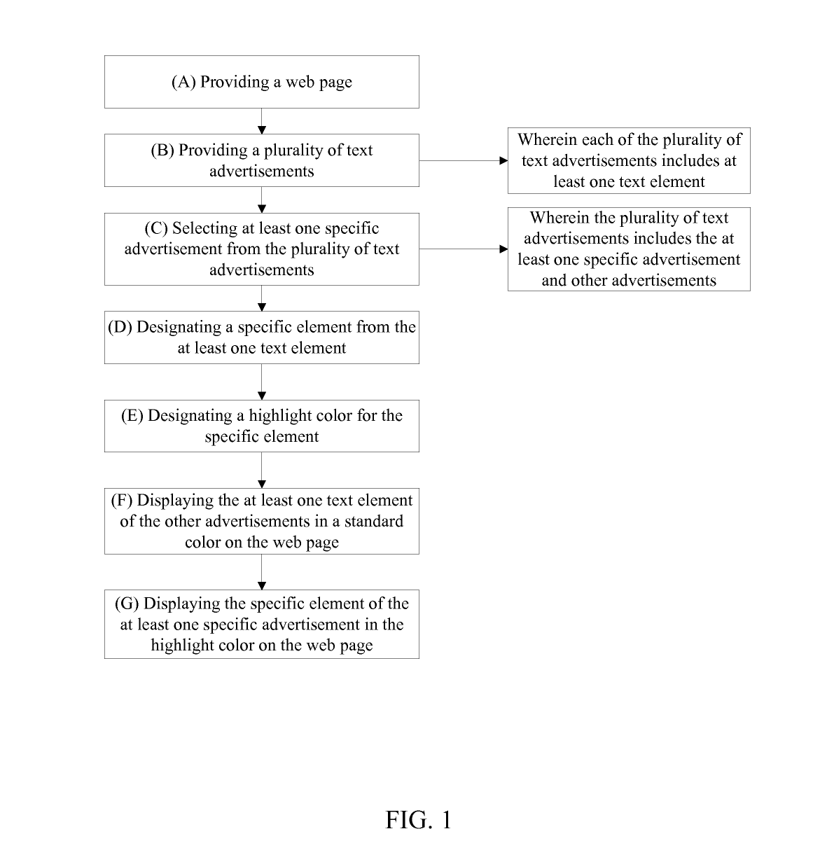

As can be seen in FIG. 1, the generalized process of the present invention is as follows. A web page is provided to be used with the present invention. The web page may be a search engine results page, a weblog, a news site, a personal website or any other type of website that displays text advertisements. A plurality of text advertisements is provided as well, wherein each of the plurality of text advertisements includes at least one text element. As previously described, the at least one text element includes, but is not limited to, keywords, titles, body text, and web address links. At least one specific advertisement is selected to be highlighted from the plurality of text advertisements, wherein the plurality of advertisements includes the at least one specific advertisement and other advertisements. In one embodiment of the present invention, the at least one specific advertisement is a single advertisement. In another embodiment of the present invention, the at least one specific advertisement is two or more advertisements that are highlighted simultaneously. In the latter case, the two or more advertisements are preferably highlighted in different colors. In another embodiment, the two or more advertisements are highlighted in the same color. The decision of simultaneously highlighting two or more advertisements in either the same color or different colors may be made by the website owner, or by the advertising provider.

Once the at least one specific advertisement is selected, a specific element is designated from the at least one text element and a highlight color is designated for the specific element to be displayed in. Displaying the specific element in the highlight color means to display the font color of the text of the specific element in the highlight color. The at least one text element from each of the other advertisements is displayed in a standard color on the web page, and the specific element of the at least one specific advertisement is displayed in the highlight color on the web page.

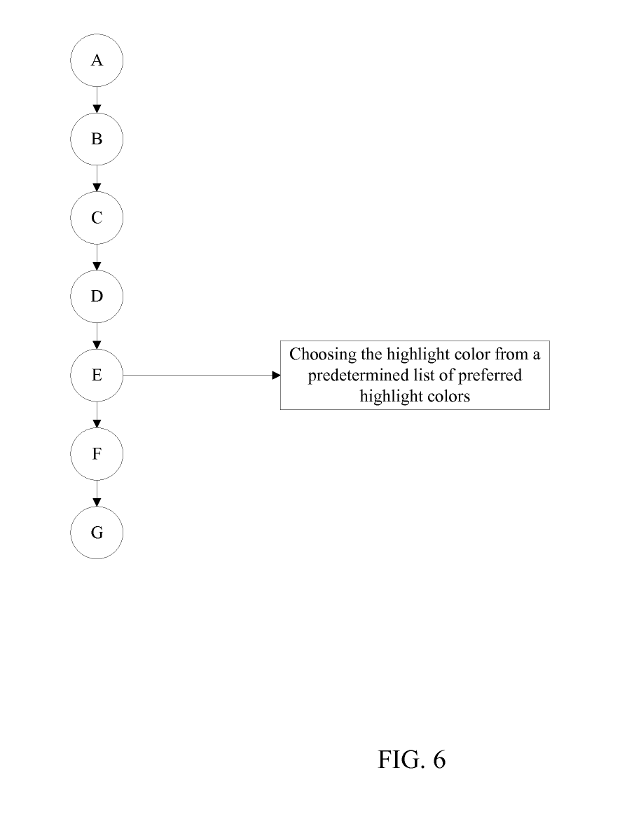

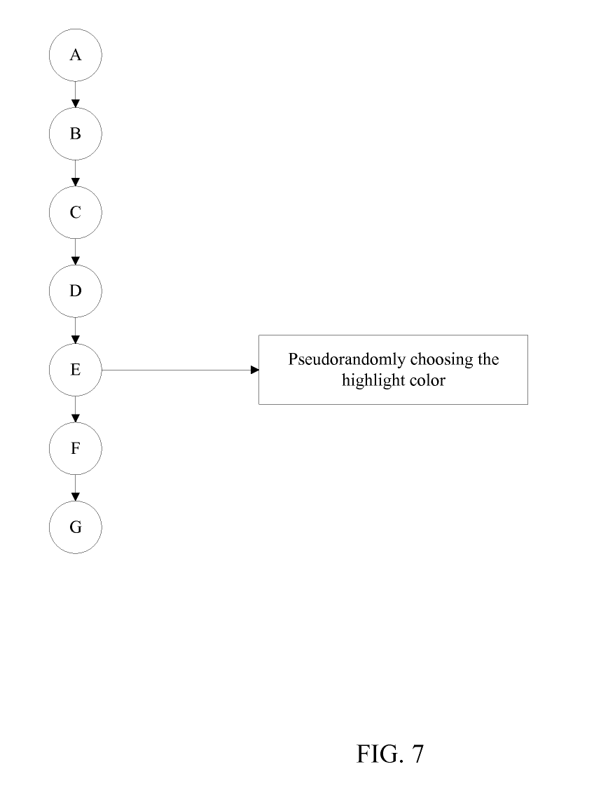

In reference to FIGS. 6-7, in the preferred embodiment of the present invention, the highlight color is chosen from a predetermined list of preferred highlight colors, provided by the web site owner, advertising provider, or other relevant party. In other embodiments of the present invention, the highlight color is chosen pseudo-randomly from all colors, from preferred color ranges, choosing the highlight color relative to the background color of the web page, or using another method.

In the preferred embodiment of the present invention, the specific element is highlighted dynamically. What this means is that the specific element is initially displayed in the standard color along with the rest of the plurality of text advertisements upon loading the web page, and gradually changes to the highlight color over a period of time as the user views the web page. In another embodiment of the present invention, the specific element is highlighted statically. In other words, the specific element is displayed in the highlight color immediately upon loading the web page, and the user does not ever see the specific element displayed in the standard color.

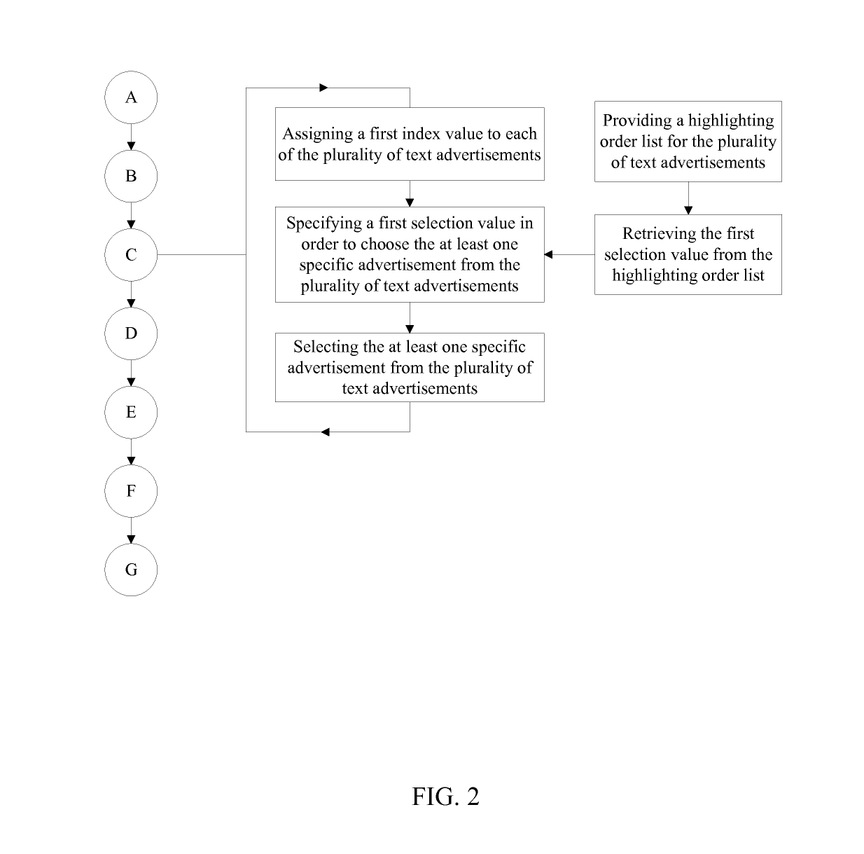

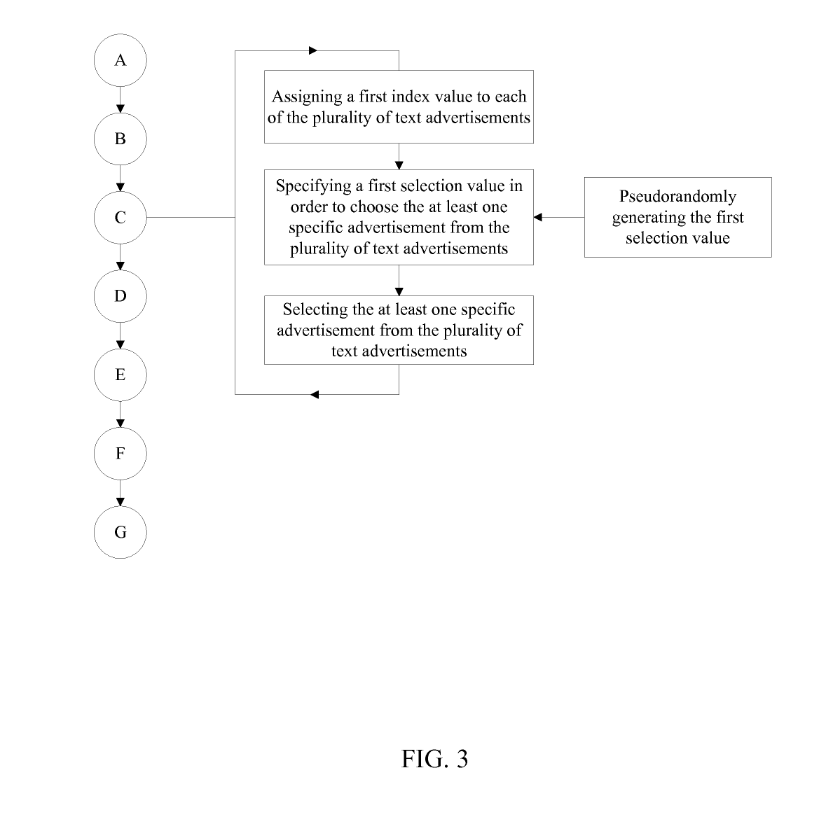

Referring to FIGS. 2-4, in the preferred embodiment of the present invention, a method for designating the specific element is as follows. As can be seen in FIGS. 2-3, a first index value is assigned to each of the plurality of text advertisements. The first index value may be hard coded into the web page, or the first index value may be dynamically assigned if the web page dynamically retrieves or generates and displays the plurality of text advertisements on each page view.

A first selection value is then specified in order to choose the at least one specific advertisement from the plurality of text advertisements. The at least one specific advertisement is selected from the plurality of text advertisements by comparing the first selection value to the first index value for each of the plurality of text advertisements. The at least one specific advertisement is chosen so that the first index value of the at least one specific advertisement is equal to the first selection value. In the case that multiple of the plurality of text advertisements are highlighted simultaneously, this step is repeated for as many times as necessary to choose the appropriate amount of text advertisements to highlight as determined by the web site owner, advertising provider or other relevant party.

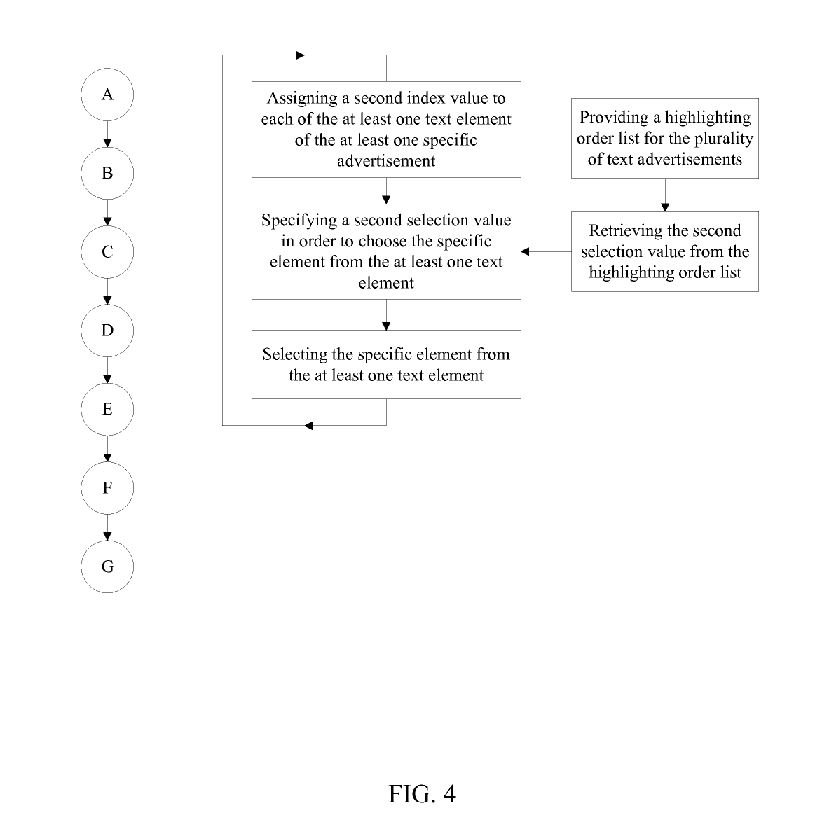

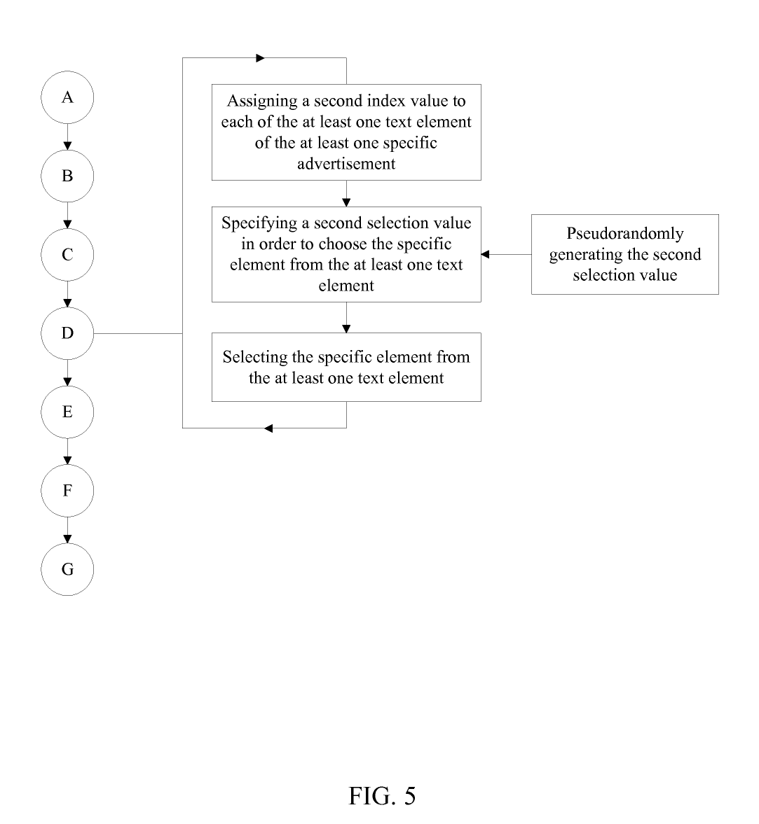

As illustrated in FIGS. 4-5, a similar process takes place to choose the specific element from the at least one specific advertisement. A second index value is assigned to each of the at least one text element of the at least one specific advertisement. A second selection value is specified in order to choose the specific element from the at least one text element. The specific element is selected from the at least one text element by comparing the second selection value to the second index value for each of the at least one text element. The specific element is chosen so that the second index value of the specific element is equal to the second selection value. In the case that multiple of the at least one text element of the at least one specific advertisement are highlighted simultaneously, this step is repeated for as many times as necessary to choose the appropriate number of specific elements to highlight. It should be noted that it is also a function of the present invention to omit the step for choosing and highlighting the specific element and to simply highlight the entirety of the at least one specific advertisement.

The first index value, the second index value, the first selection value, and the second selection value determine the order for highlighting the specific element of the at least one specific advertisement. The first index value and the second index value are reference values for choosing from the plurality of text advertisements and from the at least one text element, respectively. The first index value and the second index value are determined in a manner as seen fit by the web site owner. The first index value and the second index value may be dynamically determined by the arrangement of the plurality of text advertisements on the web page, by a list order specified by the web site owner, advertising provider or other relevant party, or by any other appropriate method.

The first selection value and the second selection value are used to choose the at least one specific advertisement from the plurality of text advertisements and to choose the specific element from the at least one text element, respectively. As shown in FIGS. 3 and 5, in the preferred embodiment of the present invention, the first selection value and the second selection value are pseudorandomly generated numbers. In another embodiment of the present invention as shown in FIGS. 2 and 4, a highlighting order list is provided for the plurality of text advertisements, from which the first selection value and the second selection value are retrieved. The highlighting order list predetermines a sequential pattern for highlighting the at least one text element of the plurality of text advertisements on the web page. In other embodiments of the present invention, other methods are used for specifying the first selection value and the second selection value, such as, but not limited to, weighting the probability of any one or more given ads being highlighted on any given page view. For example, a web page has four text advertisements. The owner of the example web page weights the four text advertisements such that the first text advertisement is highlighted twice as often as the second text advertisement, three times as often as the third text advertisement, and four times as often as the fourth text advertisement.

After the first selection value and the second selection value are specified, the specific element is displayed on the web page in the highlight color. In the preferred embodiment of the present invention, each of the plurality of text advertisements are initially displayed in the standard color upon loading the web page, and the specific element is gradually changed from the standard color to the highlight color. As previously discussed, more than one specific element may be dynamically changed in this manner.

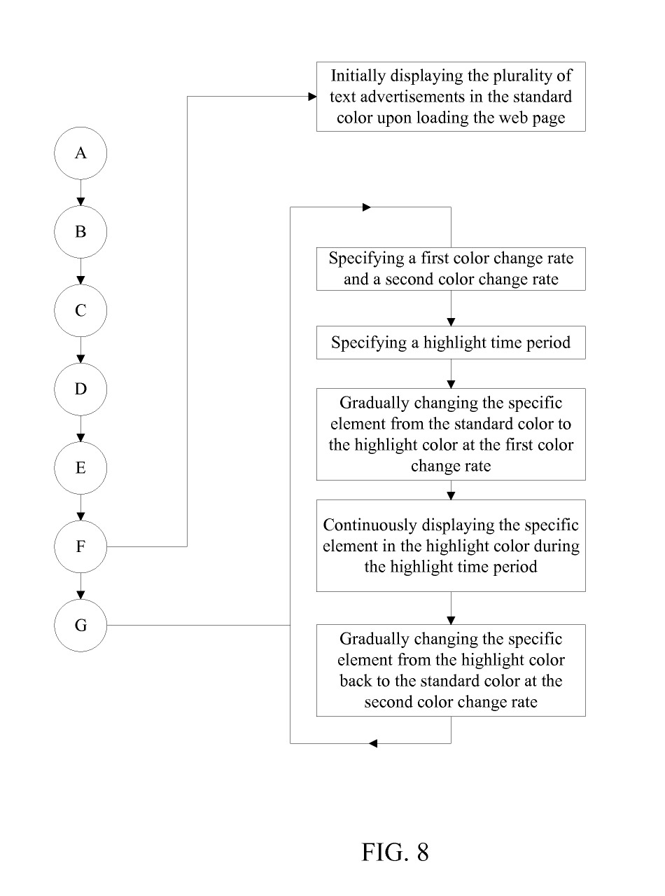

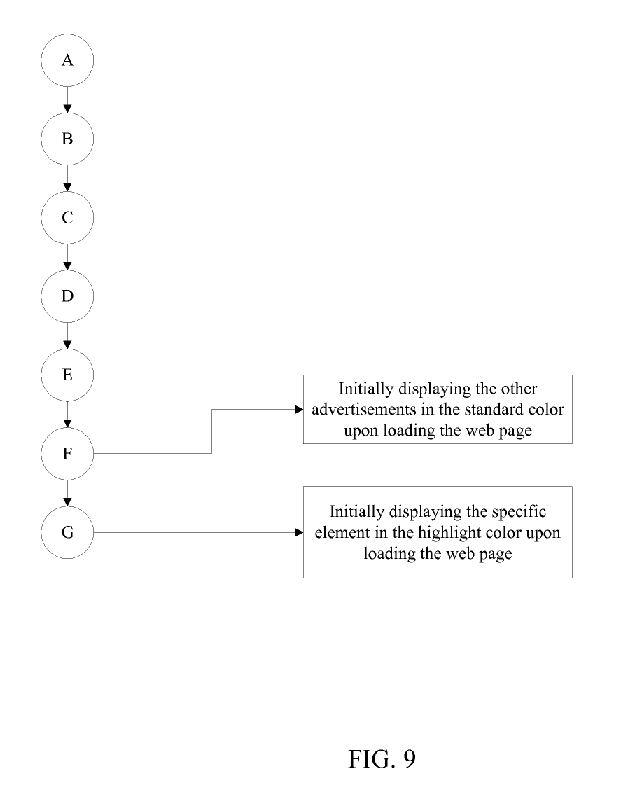

As can be seen in FIG. 8, the process for dynamically displaying the specific element of the at least one specific advertisement in the highlight color on the web page color is as follows. In the preferred embodiment of the present invention, a first color change rate and a second color change rate are specified. The first color change rate determines how long it takes for the specific element to change from the standard color to the highlight color, and the second color change rate determines how long it takes for the specific element to change from the highlight color back to the standard color. A highlight time period is also specified, wherein the highlight time period defines how long the specific element is displayed in the highlight color. Upon loading the web page, the plurality of text advertisements is displayed in the standard color, including the specific element. The specific element is then gradually changed from the standard color to the highlight color at the first color change rate, wherein the specific element is changed to the highlight color after loading the web page. The specific element is continuously displayed in the highlight color during the highlight time period, and then the specific element is gradually changed from the highlight color back to the standard color at the second color change rate. As shown in FIG. 9, in the embodiment where the specific element is highlighted statically, the specific element is initially displayed in the highlight color upon loading the web page, while the other advertisements are displayed in the standard color upon loading the web page.

The first color change rate and the second color change rate may be equal or different based on the discretion of the web site owner. The first color change rate and the second color change rate may be different or equal for each highlighting cycle. In the embodiment where the specific element is statically highlighted on the web page, that is, the specific element is displayed in the highlight color upon loading the web page for as long as the user views the web page, the first color change rate, the second color change rate, and the highlight time period are not applicable.

The advertising provider may provide the website owner with options to manage the unit text ad, such as, but not limited to, a dashboard or control panel feature, or a simple option to activate the functionality of the present invention with the unit text ad. The advertising provider or web site owner may choose which of the plurality of text advertisements to highlight using the present invention, and may omit some of the plurality of text advertisements from being highlighted using the present invention.

Although the invention has been explained in relation to its preferred embodiment, it is to be understood that many other possible modifications and variations can be made without departing from the spirit and scope of the invention as hereinafter claimed.

1. A non-transitory computer-readable medium that stores instructions executable by one or more processors to perform a method of improving, the method comprises:
instructions for providing a web page;
instructions for providing a plurality of text advertisements, wherein each of the plurality of text advertisements includes at least one text element;
instructions for assigning a first index value to each of the plurality of text advertisements;
instructions for specifying a first selection value in order to choose the at least one specific advertisement from the plurality of text advertisements;
instructions for selecting the at least one specific advertisement from the plurality of text advertisements by comparing the first selection value to the first index value of each of the plurality of text advertisements, wherein the first index value of the at least one specific advertisement is equal to the first selection value;
instructions for selecting at least one specific advertisement from the plurality of text advertisements, wherein the plurality of text advertisements includes the at least one specific advertisement and other advertisements;
instructions for assigning a second index value to each of the at least one text element of the at least one specific advertisement;
instructions for specifying a second selection value in order to choose the specific element from the at least one text element;
instructions for designating the specific element from the at least one text element by comparing the second selection value to the second index value of each of the at least one text element, wherein the second index value of the specific element is equal to the second selection value;
instructions for designating a highlight color for the specific element, wherein the highlight color is chosen pseudorandomly;
instructions for initially displaying the plurality of text advertisements in the standard color upon loading the web page;
instructions for gradually changing the specific element from the standard color to the highlight color;
instructions for the first selection value and the second selection value being pseudorandomly generated numbers;
instructions for selecting the highlight color from a predetermined list of preferred highlight colors,
instructions for making a part of said at least one specific advertisement dynamically highlighted and another part of said at least one specific advertisement statically highlighted at a same time.

2. (canceled)

3. (canceled)

4. The non-transitory computer-readable medium that stores instructions executable by one or more processors to perform the method of improving internet text advertisement visibility as claimed in claim 1 comprises the steps of:
instructions for providing a highlighting order list for the plurality of text advertisements, wherein the highlighting order list predetermines a sequential pattern for highlighting the at least one text element of the plurality of text advertisements on the web page; and
instructions for retrieving the first selection value and the second selection value from the highlighting order list.

5. (canceled)

6. (canceled)

7. (canceled)

8. The non-transitory computer-readable medium that stores instructions executable by one or more processors to perform the method of improving internet text advertisement visibility as claimed in claim 1 comprises:
instructions for specifying a first color change rate and a second color change rate;
instructions for specifying a highlight time period, wherein the highlight time period defines how long the specific element is displayed in the highlight color;
instructions for initially displaying the plurality of text advertisements in the standard color upon loading the web page;
instructions for gradually changing the specific element from the standard color to the highlight color at the first color change rate, wherein the specific element is changed to the highlight color after loading the web page;
instructions for continuously displaying the specific element in the highlight color during the highlight time period; and
instructions for gradually changing the specific element from the highlight color back to the standard color at the second color change rate.

9. (canceled)

10. (canceled)

11. A non-transitory computer-readable medium that stores instructions executable by one or more processors to perform a method of improving internet text advertisement visibility, the method comprises:
instructions for providing a web page;
instructions for providing a plurality of text advertisements, wherein each of the plurality of text advertisements includes at least one text element;
instructions for assigning a first index value to each of the plurality of text advertisements, wherein the plurality of text advertisements includes at least one specific advertisement and other advertisements;
instructions for specifying a first selection value in order to choose the at least one specific advertisement from the plurality of text advertisements;
instructions for selecting the at least one specific advertisement from the plurality of text advertisements by comparing the first selection value to the first index value of each of the plurality of text advertisements, wherein the first index value of the at least one specific advertisement is equal to the first selection value;
instructions for assigning a second index value to each of the at least one text element of the at least one specific advertisement, wherein the at least one text element includes keywords, titles, body text, and web address links;
instructions for specifying a second selection value in order to choose a specific element from the at least one text element;
instructions for designating the specific element from the at least one text element by comparing the second selection value to the second index value of each of the at least one text element, wherein the second index value of the specific element is equal to the second selection value;
instructions for designating a highlight color for the specific element; wherein the highlight color is chosen pseudorandomly, and the highlight color is chosen from a predetermined list of preferred highlight colors;
instructions for initially displaying the plurality of text advertisements in the standard color upon loading the web page;
instructions for gradually changing the specific element of the at least one specific advertisement from the standard color to the highlight color;
instructions for providing a highlighting order list for the plurality of text advertisements, wherein the highlighting order list predetermines a sequential pattern for highlighting the at least one text element of the plurality of text advertisements on the web page;
instructions for making a part of said at least one specific advertisement dynamically highlighted and another part of said at least one specific advertisement statically highlighted at a same time; and
instructions for retrieving the first selection value and the second selection value from the highlighting order list.

12. The non-transitory computer-readable medium that stores instructions executable by one or more processors to perform the method of improving internet text advertisement visibility as claimed in claim 11, wherein the first selection value and the second selection value are pseudorandomly generated numbers.

13. (canceled)

14. The non-transitory computer-readable medium that stores instructions executable by one or more processors to perform the method of improving internet text advertisement visibility as claimed in claim 11 comprises,
instructions for specifying a first color change rate and a second color change rate;
instructions for specifying a highlight time period, wherein the highlight time period defines how long the specific element is displayed in the highlight color;
instructions for initially displaying the plurality of text advertisements in the standard color upon loading the web page;
instructions for gradually changing the specific element from the standard color to the highlight color at the first color change rate, wherein the specific element is changed to the highlight color after loading the web page;
instructions for continuously displaying the specific element in the highlight color during the highlight time period; and
instructions for gradually changing the specific element from the highlight color back to the standard color at the second color change rate.

15. (canceled)

16. (canceled)

17. A non-transitory computer-readable medium that stores instructions executable by one or more processors to perform a method of improving internet text advertisement visibility, the method comprises:
instructions for providing a web page;
instructions for providing a plurality of text advertisements, wherein each of the plurality of text advertisements includes at least one text element;
instructions for selecting at least one specific advertisement from the plurality of text advertisements, wherein the plurality of text advertisements includes the at least one specific advertisement and other advertisements;
instructions for designating a specific element from the at least one text element, wherein the at least one text element includes keywords, titles, body text, and web address links;
instructions for designating a highlight color for the specific element;
instructions for specifying a first color change rate and a second color change rate;
instructions for specifying a highlight time period, wherein the highlight time period defines how long the specific element is displayed in the highlight color;
instructions for initially displaying the plurality of text advertisements in the standard color upon loading the web page;
instructions for gradually changing the specific element of the at least one specific advertisement from the standard color to the highlight color at the first color change rate, wherein the specific element is changed to the highlight color after loading the web page;
instructions for making a part of said at least one specific advertisement dynamically highlighted and another part of said at least one specific advertisement statically highlighted at a same time;
instructions for continuously displaying the specific element in the highlight color during the highlight time period;
instructions for gradually changing the specific element from the highlight color back to the standard color at the second color change rate;
instructions for assigning a first index value to each of the plurality of text advertisements;
instructions for specifying a first selection value in order to choose the at least one specific advertisement from the plurality of text advertisements;
instructions for selecting the at least one specific advertisement from the plurality of text advertisements by comparing the first selection value to the first index value of each of the plurality of text advertisements, wherein the first index value of the at least one specific advertisement is equal to the first selection value;
instructions for providing a highlighting order list for the plurality of text advertisements, wherein the highlighting order list predetermines a sequential pattern for highlighting the at least one text element of the plurality of text advertisements on the web page;
instructions for retrieving the first selection value and the second selection value from the highlighting order list;
instructions for assigning a second index value to each of the at least one text element of the at least one specific advertisement;
instructions for specifying a second selection value in order to choose the specific element from the at least one text element;
instructions for selecting the specific element from the at least one text element by comparing the second selection value to the second index value of each of the at least one text element, wherein the second index value of the specific element is equal to the second selection value;
instructions for initially displaying the plurality of text advertisements in the standard color upon loading the web page;
instructions for gradually changing the specific element from the standard color to the highlight color;
instructions for providing a highlighting order list for the plurality of text advertisements, wherein the highlighting order list predetermines a sequential pattern for highlighting the at least one text element of the plurality of text advertisements on the web page; and
instructions for retrieving the first selection value and the second selection value from the highlighting order list.

18. (canceled)

19. The non-transitory computer-readable medium that stores instructions executable by one or more processors to perform the method of improving internet text advertisement visibility as claimed in claim 17, wherein the first selection value and the second selection value are pseudorandomly generated numbers.

20. (canceled)
